(19) United States
(12) Patent Application Publication
(10) Pub. No.: US 2002/0048662 A1
(43) Pub. Date: Apr. 25, 2002

(54) Method of and apparatus for producing a printed ink pattern on a tissue product, as well as a printed tissue product as such

(75) Inventors: Gunnar Bredahl, Worms (DE); Gunther Zoller, Schriesheim (DE); Dieter Bocher, Altenbeuern (DE)

Correspondence Address: DARBY & DARBY, 805 THIRD AVENUE, 27TH FLR., NEW YORK, NY, 10022, US

(73) Assignee: SCA HYGIENE PRODUCTS GmbH

(21) Appl. No.: 09/967,470

(22) Filed: Sep. 27, 2001

Related U.S. Application Data
(60) Provisional application No. 60/236,124, filed on Sep. 28, 2000.

(51) Int. Cl. B32B 3/00

(52) U.S. Cl. 428/195; 118/46; 101/3.1

(57) ABSTRACT

The present invention relates to a method of and an apparatus for producing a printed ink pattern on a tissue. The method comprises the steps of applying ink onto a first embossing roll, passing the at least two plies through a nip formed between the first embossing roll and a second embossing roll, and embossing the at least two plies in the nip and simultaneously printing the ink onto a surface of the plies being embossed which surface defines an exterior surface of the tissue. The apparatus comprises a first embossing roll and a second embossing roll, the first and second embossing rolls forming an embossing nip therebetween, and an ink applying device. The ink applying device is arranged to apply ink onto the first embossing roll at such a position that, simultaneously to the embossing of the at least two plies in the nip, the ink is printed in the nip onto the exterior surface of the plies being embossed.

The present invention relates to a method of and an apparatus for producing a printed ink pattern an a tissue having at least two plies, and to a tissue obtained by way of such a method. As used here, the term “tissue” is to be understood to also include so-called non-woven products and textiles. In particular, the invention relates to hygiene and other products such as serviettes, handkerchiefs, kitchen towels, make-up removal towels, toilet paper, wipes and the like.

Products of the above-mentioned type have two or more plies and, for example, to impart a more pleasing appearance attractive to the user, can be provided with a pattern consisting of one or more colours, the pattern extending over a part or the entire area of the tissue product.

### DESCRIPTION OF RELATED ART

It is known with regard to tissue products such as hygiene products to provide various kinds of product design. Examples include coloured serviettes produced from tissue webs entirely coloured with one or more colours. In this case, the colour is already introduced into the process of making the tissue web. Other processes adopt the printing of tissue products on one or both sides. This is well known in all areas of tissue products including toilet paper, household rolls and handkerchiefs. In this case, a tissue web is printed with ink or the like during processing of the tissue web into the final product. Various possibilities exist with regard to the coloured design, e.g., by mixing the inks or the like on application (so-called process printing) or by simply printing previously mixed dyes.

It is to be noted that, in the context of the present invention, the term ink should be understood to include pigment, Lint, dye, toner, or any other colouring matter.

A paper or like laminate is known from GB-A-2255754 and comprises two plies, at least one of which is at least partially translucent, embossed and attached to the other ply at the embossings. Colouring matter is provided between the plies such that the colouring is visible where points of the first sheet are in engagement with the second sheet. CA-A-2124240 teaches a multi-ply tissue having two or more internal ply surfaces, one or more of which has a coloured or patterned indicia thereon which is visible through at least one of the outer plies of the tissue. A particular disadvantage with respect to the tissue products of the type known from these two publications is that the pattern produced by printing of the colouring matter on an internal surface of one or more of the plies gives the impression of being faded, which may not always be desirable. Further, in view of the fact that the printed pattern is on an internal surface of the tissue, there is no need to achieve a perfect print in terms of correlation of the printed areas with other parts of the plies of tissue such as embossed areas, for example, because any defect is hidden to some extent by the ply thereabove and not easily recognisable.

Other printed products having the pattern printed on the exterior surface of the tissue have a more or less good degree of quality, but all have in common that a pattern printed on an external surface of the product is distorted, i.e. the pattern has an insufficient raster correlation (in German: Rasterhaltigkeit) in that the printed elements of the pattern are not in correlation with the predesigned raster pattern, or, if desired, with the embossing pattern. This is because it is difficult to exactly correlate the print with other elements of the tissue web, for example, the embossing or perforations or other printed patterns on the web. It is presently not unknown to have deviations of several tenths of a millimeter. This problem stems from the fact that the printed pattern must be applied in a separate operation, for example, before or after the embossing operation. Fluctuating tensions in the tissue web lead to the printed pattern “slipping” so that the optical impression of the printed pattern of the product, and therefore also of the entire product, is significantly deteriorated.

### SUMMARY

Based on the above, the present invention has been made to solve the problem of providing a method of producing a tissue product which does not suffer from the above drawbacks and has a printed pattern which is clearly visible and still has optimal raster correlation. It is a further object of the present invention to provide an apparatus for producing such a tissue product and to provide a tissue product without the above-mentioned deficiencies.

These objects are solved by a method comprising the features of claim 1, an apparatus comprising the features of claim 12 and a product comprising the features of claim 29 or 30. Advantageous further embodiments are defined in the dependent claims.

The inventive solution of the above-mentioned problems consist in effecting the printing process at the same time as the embossing of the tissue product so that there is perfect correlation between the printed and embossed patterns. This also provides the advantage of reducing the number of operational steps required to make the final product. Thus, the present invention is realized by a so-called coloured embossing, in which the printing and embossing steps are performed simultaneously. For example, one or both of the embossing rolls are continuously coated with ink before the actual embossing step is performed in the nip between the two embossing rolls. In this case, when the embossing protuberances on the embossing roll press into the tissue material of the at least two plies making up the tissue product in order to press the plies together, the transfer of the ink takes place simultaneously at the desired location without any risk of “slippage” known in previous systems. Thus, one or both external sides of the embossed tissue product is or are printed with the designed pattern in such a manner that there is an exact correlation of the areas of print with the areas of embossing. Therefore, the raster correlation can be optimized even though this is achieved in a relatively simple manner without complicated processing steps or the need for complicated additional machinery. Rather, the embossing of the tissue is utilized not only additionally for printing, but moreover for an infallable positioning of the printed pattern at the desired location.

Additionally, in contrast to already known processes and products, the inventive process and apparatus implies that it is not necessary to use an adhesive, in particular, for example, to produce a bond between the plies of the tissue product. Further, as the ink is applied to the exterior of the tissue product in a manner positioned precisely with regard to the embossed pattern, a clear and distinctive coloured pattern of high definition is achieved.

The present invention will now be described by way of preferred exemplary embodiments with reference to the accompanying drawings, wherein:

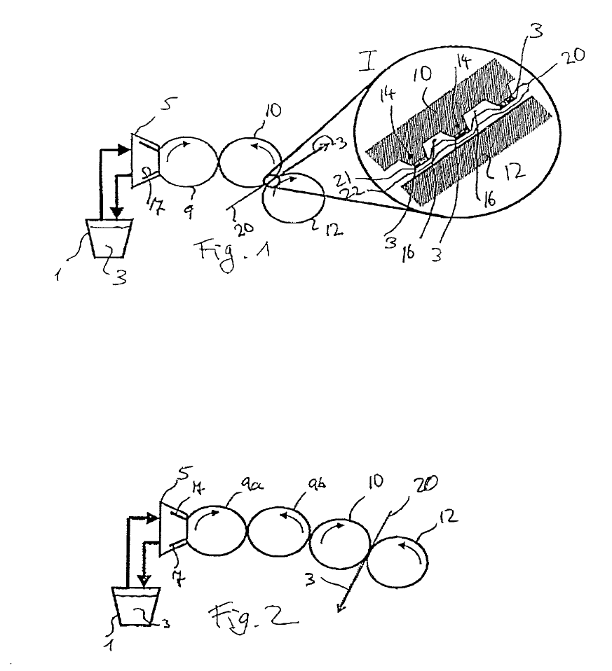

FIG. 1 shows a schematic view of an apparatus according to a first embodiment of the present invention and a detail of the simultaneous embossing and printing of a two-ply tissue at the nip between the embossing rolls;

FIG. 2 shows a second embodiment of an apparatus according to the present invention;

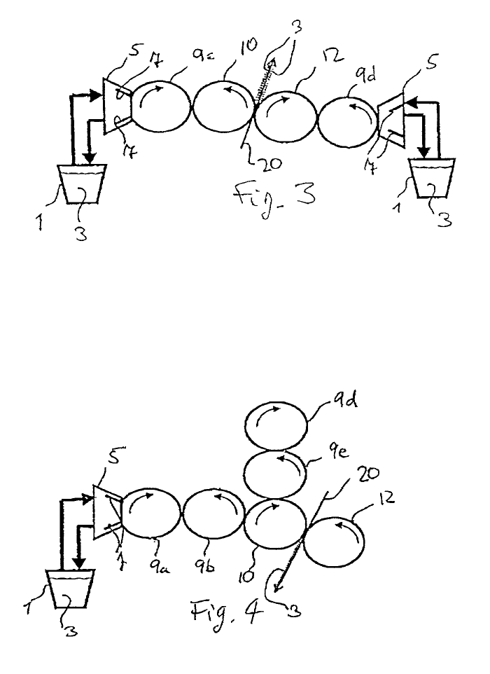

FIG. 3 shows a third embodiment of an apparatus according to the present invention;

FIG. 4 shows a fourth embodiment of an apparatus according to the present invention;

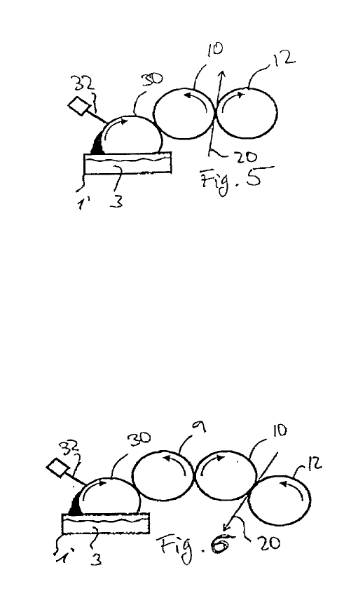

FIG. 5 shows a fifth embodiment of an apparatus according to the present invention similar to that of FIG. 1; and

FIG. 6 shows a sixth embodiment of an apparatus according to the present invention similar to that of FIG. 2.

### DESCRIPTION OF THE PREFERRED EMBODIMENTS OF THE INVENTION

The apparatus, method and product in accordance with the present invention will now be further described, initially by way of reference to FIG. 1.

In FIG. 1, reference numeral 1 denotes an ink reservoir, holding a sufficient supply of typically liquid ink 3. The ink reservoir 1 is connected by way of suitable conduits for the ink to an inking chamber 5. The inking chamber 5, in turn, comprises one or more doctor blades 7. in combination, the ink reservoir 1, the inking chamber 5 and the doctor blades 7 supply an ink transfer roll 9 with the desired amount of ink, and thus form a supply system or a supply unit for the next adjacent element. Such an ink supplying system is generally referred to as a chamber doctor blade system (in German: Kammerrakelsystem). Typically, the ink is applied to the entire surface area of the ink transfer roll 9, and the desired amount of the applied ink is adjusted by a first doctor blade, a second doctor blade being provided to remove unused ink from the ink transfer roll 9 back to the ink reservoir 1.

In the embodiment of FIG. 1, the ink transfer roll 9 is arranged to contact a first embossing roll 10. The ink applied to the surface of the ink transfer roll will be transferred to the first embossing roll 10. The materials selected for the ink transfer roll 9 and the first embossing roll 10 may enhance this transfer effect. Typically, the materials selected for the first embossing roll 10 will be selected to best fulfil the desired embossing effect. Therefore, the material selected for the ink transfer roll 9 will have to match the materials selected for the first embossing roll 10, while at the same time delivering the desired controlled transfer effect. Suitable materials for these rolls are stainless steel for the first embossing roll 10, and a flexible or resilient material such as rubber for at least the surface of the ink transfer roll 9.

As can further be taken from FIG. 1, the first embossing roll 10 is arranged to form a press nip with a second embossing roll 12, through which press nip the desired number of tissue plies to form tissue 20 passes in the direction indicated by an arrow.

The arrangement of the first embossing roll 10 and the second embossing roll 12 relative to one another and the plies of tissue 20 passing through the nip between these two rolls may better be taken from the enlarged schematic detail drawing I of FIG. 1.

In detail I, the radii of curvature of the first and second embossing rolls 10, 12 were simplified and are represented as straight lines.

From detail I, it is particularly evident how the first embossing roll 10 is provided with protuberances 14 and depressions 16. In the particular depicted embodiment, the second embossing roll 12 is a plane roll, in other words it is not provided with any protuberances or depressions and may be referred to as a backing roll for the first embossing roll 10. Naturally, a profiled second embossing roll 12 may be used instead, if the desired embossing requires this, for example, to form nested or foot-to-foot embossing.

The ink 3 transferred by means of the ink transfer roll 9 onto the first embossing roll 10 will, upon suitable selection of the relative arrangement of rolls 9 and 10 and a suitable choice of the selected materials, be transferred only onto the surfaces of the protuberances 14. It is preferred that the depressions 16 are devoid of any ink 3. In the alternative, however, it is equally possible to only provide ink in the depressions 16 and leave the protuberances 14 devoid of ink.

Turning now to the tissue 20 depicted in detail I of FIG. 1, the tissue 20 is evidently a multi-ply tissue. In particular, it comprises a first ply 21 and a second ply 22. The plies pass through the nip between the first and second embossing rolls 10, 12 in the direction indicated by the arrow in FIG. 1. The embossing rolls turn correspondingly, so that there is no relative movement between the contacting surfaces of the first and second embossing rolls 10, 12 on the one hand, and between the surface of either roll and the tissue 20 on the other hand. In particular, it is preferred that there is no relative movement between the first ply 21 and the second ply 22.

Passing the tissue plies 21, 22 through the nip between the first embossing roll 10 and the second embossing roll 12 will impart a pattern to the otherwise pattern-free tissue 20. Moreover, imparting this pattern to the tissue 20 can be effected in dependence on the adjustment of the nip to plastically deform the first ply 21 and the second ply 22 and press them to such an extent that a mechanical bonding is produced between these two plies 21 and 22, or the nip can be adjusted to only impart a structure to the plies without a mechanical bond being produced. After having passed through the press nip, tissue 20 will be handable without a separation of plies 21 and 22.

The embodiment depicted in FIG. 1 and described with reference thereto imparts a coloured pattern to only one external side of a tissue 20 consisting of two plies. However, from the foregoing description, it should be clear to a person having average skill in the art that in the embodiment of FIG. 1, it is also possible to impart this one-sided print pattern of ink to a tissue having more than two plies. Further, it is also possible to replace the backing-type second embossing roll 12 with an embossing roll having a configuration similar or different to the first embossing roll 10. The second embossing roll 12 would then have corresponding protuberances and depressions. These protuberances and depressions could be arranged so that the protuberances of the first embossing roll 10 contact protuberances of the second embossing roll 12. Alternatively, the protuberances of one embossing roll could mesh with the depressions of the second embossing roll 12, depending on the desired extent to which the embossing is to be carried out.

FIG. 2 illustrates a second embodiment of the present invention. In FIG. 2, like reference numerals are used to designate elements corresponding to those of the embodiment of FIG. 1. In particular, these are the ink reservoir 1, the ink 3, the inking chamber 5 and the inking chamber doctor blades 7, which function in a manner identical to that of the corresponding elements of the FIG. 1 embodiment. Further, the first embossing roll 10 and the second embossing roll 12 of the embodiment of FIG. 1 are also present in the embodiment of FIG. 2.

This embodiment of FIG. 2 offers a broader range for individually selecting materials for the various rolls. For example, in the embodiment of FIG. 2, the first ink transfer roll 9a could typically be manufactured from stainless steel, and the second ink transfer roll 9b from rubber. This is especially advantageous if the first embossing roll 10 is also of steel as it improves the transfer of ink as compared to the transfer of ink from one steel roll to another. It is also possible to design the second ink transfer roll with a pattern corresponding to the embossing pattern of or the pattern to be printed by the first embossing roll 10.

Alternatively, the first ink transfer roll may be constructed to present a pattern to a pattern-free second ink transfer roll 9b. Further, alternatively or additionally, the patterns of the first ink transfer roll 9a and/or the second ink transfer roll 9b, which would typically be formed by protuberances and depressions, could comprise protuberances of different height. In other words, the outer surface of some protuberances could be located at a distance from the central axis of the ink transfer roll different from the corresponding distance of adjacent protuberances. In this manner, the opportunity is open to selectively coat some of the protuberances with ink, so as to use these protuberances for embossing and printing and others for embossing only. In particular, it is possible to use a roll with protuberances over its entire surface, or only over a part thereof, depending on the desired pattern to be printed.

In the embodiment of FIG. 1 and FIG. 2, the method of supplying ink to the next adjacent roll is identical. Further, both embodiments are for the one-sided printing of tissue 20. In both embodiments, FIG. 1 and FIG. 2, the ink 3 is transferred from an ink reservoir 1 by suitable means to at least one ink transfer roll 9, 9a, 9b. From there, the ink is transferred onto a first embossing roll 10 which, in turn, transfers the ink onto one external surface of tissue 20 at precisely the desired location. Since the tissue will typically have materials properties permitting the absorption of ink, a precise unidirectional transfer of the ink 3 from the first embossing roll 10 onto the tissue 20, simultaneously with embossing two or more plies of the tissue so as to bond them to one another, can be obtained. it will be evident to a skilled person that, although the selection of materials for the ink transfer roll or rolls presently preferred is rubber, plastic, leather, or another similar flexible material, and that for the first and second embossing rolls is stainless steel, other selections of materials for each of the rolls are possible within the scope of the present invention. In particular, it is also possible to manufacture the three rolls 9, 10 and 12 from the same material. Transfer of ink has proven to still be possible.

Now with reference to FIG. 3, it will be described how the apparatus and the method of present invention can be used for two-sided printing, and correspondingly how the inventive product with a two-sided pattern can be obtained.

In the embodiment of FIG. 3, two ink reservoirs 1, 1 containing ink 3 and being connected to inking chambers 5, 5 with doctor blades 7, 7 are provided. Preferably the two ink reservoirs and the connected structure will be identical. Naturally, it is also possible to have these elements be constructed and arranged differently, as would be apparent to a person skilled in the art. In particular, the ink in one reservoir can have a colour different from that in the other reservoir, and the amounts supplied can be different and the ink reservoir 1, the inking chamber 5 and inking chamber doctor blades 7 be designed accordingly.

Further in the embodiment of FIG. 3, like parts are designated by the same reference numerals as in the embodiments of FIG. 1 and 2. In the FIG. 3 embodiment, the desired number of plies of the tissue 20 are passed through a nip formed between a first embossing roll 10 and a second embossing roll 12. The direction of passing of the tissue plies is, in the Figure, from the lower left-hand side to the upper right hand side, as also indicated by an arrow. In the following, the elements arranged to the left of the tissue 20 will be referred to as the “left-hand”, those arranged to the right of the tissue 20 as the “right-hand” elements. These designations are purely for simplifying the description and are not intended to limit the arrangement of these elements relative to one another. For instance, it is also conceivable with regard to all embodiments, to arrange for the tissue 20 to pass horizontally through a nip.

Similar to the embodiments described with reference to FIGS. 1 and 2, the ink 3 is transferred from the left-hand ink reservoir 1 through suitable selected conduits to the left-hand inking chamber 5 and applied by means of an inking chamber doctor blades 7 to an ink transfer roll 9c. From this ink transfer roll 9c, the ink is further transferred by means of line contact between this roll and the first embossing roll 10 to the latter. The ink transfer roll 10 than embosses in cooperation with the second embossing roll 12 two or more plies of the tissue 20. At the same time, the first embossing roll 10 transfers all or part of the ink it carries on its outer surface to the tissue 20. Similarly, ink 3 is transferred from the right-hand ink reservoir 1 through a conduit to an inking chamber 5 and applied by means of doctor blades 7 to the ink transfer roll 9d. From there, it is transferred to the second embossing roll 12 and to the right-hand side of the tissue 20, all in a manner similar to that described with reference to FIGS. 1 and 2.

In the embodiment of FIG. 3, if it is desired, the printed tissue 20 obtained by the apparatus and method of the FIG. 3 embodiment can have two completely different patterns, one on each side of the tissue.

In this case, the amounts of ink used in the combined embossing/printing process can easily be controlled by the method of applying ink onto the respective embossing roll to be below the saturation point of the material making up half of the entire tissue thickness. Naturally, similar applies in respect of printing onto only one external surface of tissue 20 as described above with reference to FIGS. 1 and 2.

Turning now to FIG. 4, it will be described how the embodiments of FIG. 1, 2 and 3 may be modified so as to facilitate multi-colour printing. The embodiment of FIG. 4 will be explained with reference to one-sided printing, but it will be apparent to a person skilled in the art that the same arrangement may be expanded to also render possible two-sided printing of a tissue.

As shown and described with reference to FIG. 2, it is possible by way of suitably designing a second ink transfer roll 9b to selectively coat only a portion of all protuberances on the roll, The resulting printing pattern on the tissue would then only be partially coloured, which may have an aesthetically pleasant effect. In FIG. 4, an additional application unit for ink is depicted, for the sake of simplicity without the corresponding ink supply unit such as an ink reservoir 1, an inking chamber 5 and doctor blades 7. In particular, this second application unit comprises two additional ink transfer rolls 9d and 9e. However, only one or even three ink transfer rolls may be provided, depending on the type of ink and pattern to be applied.

In the specific embodiment of FIG. 4, the ink transfer roll 9e in immediate contact with the first embossing roll 10 will be designed corresponding to the design of the ink transfer roll 9b, or the protuberances of the ink transfer rolls 9b and 9e may be of different height. This design can be correlated so that the protuberances of the ink transfer roll 9b coated with ink contact the first embossing roll 10 at locations different from the ink-coated protuberances of the ink transfer roll 9e. In this manner, a first colour can selectively be supplied to a portion of the surface of the first embossing roll 10 by ink transfer roll 9b, and the remaining portions can entirely or partially be coated with ink by means of the ink transfer roll 9e. Thus, multi-colour patterns can be obtained. Alternatively or additionally, it is also possible to coat the same portions of the first embossing roll 10 with two or more layers of ink, depending on how many additional ink transfer rolls are arranged around the periphery of the first embossing roll 10. The ink colours can then be mixed, and the tissue can be provided with patterns of gradually changing colours.

Turning now to the embodiments of FIGS. 5 and 6, an alternative ink supply unit, in this case a so-called dip-cylinder system will be explained as follows.

In FIGS. 5 and 6, the desired number of plies of the tissue 20 is again passed through a nip formed between a first embossing roll 10 and a second embossing roll 12. In the embodiments of FIGS. 5 and 6, like reference numerals are used to identify elements similar to those depicted in the embodiments of FIGS. 1 to 4.

The method of imparting either a one-sided or a two-sided print pattern to tissue 20 by means of embossing rolls 10, 12, such as it is used in the embodiments of FIGS. 5 and 6 is similar to that of the previously described embodiments. In particular, one or alternatively both of the embossing rolls 10, 12 may be provided with protuberances 14 and depressions 16 (detail I of FIG. 1). Further, single or multi-colour printing as described in the previous embodiments may also be used in the embodiments of FIGS. 5 and 6. This is particularly evident from FIG. 6, where an ink transfer roll 9 is used, which is similar to that depicted and described with reference to the FIG. 1 embodiment.

However, the embodiments of FIGS. 5 and 6 make use of a different ink supply system. In the latter embodiments, an ink reservoir 1′ is used to hold a sufficiently large supply of ink 3. The ink reservoir 1′ has dimensions suitably large to permit a dip cylinder 30 to enter with its entire axial length into the ink 3 contained in the ink reservoir 1′. Preferably, but not necessarily, the dip cylinder 30 will have longitudinal dimensions corresponding to those of the first embossing roll 10.

The dip cylinder 30 rotates in preferably constant contact with the ink 3 in the ink reservoir 1′. Due to the materials properties of the surface of the dip cylinder 30 and the ink 3, and the resulting friction and/or adhesion therebetween, the surface of the dip cylinder 30 will entrain part of the ink 3 contained in the ink reservoir 1′, as also indicated in FIGS. 5 and 6. The entrained ink can subsequently be transferred onto the ink transfer roll 9 or directly onto the first embossing roll 10, and subsequently to the tissue 20. So as to control the amount of ink supplied by the ink supply mechanism of FIGS. 5 and 6, a wiper 32 is provided. The wiper 32 wipes excess ink off the dip cylinder 30, so that only the desired amount of ink will be supplied to the tissue 20. The ink wiped off the dip cylinder 30 will flow back into the ink reservoir 1′.

Naturally, it is contemplated within the scope of the present invention to utilise ink supply mechanism others than those depicted in FIGS. 1-4 and 5-6, respectively. For example, the ink could be applied onto the first embossing roll 10 and/or the second embossing roll 12 by way of spraying, brushing, other doctor blade systems, or other ways of applying paint or ink. Further, any suitable combination of smooth and profiled rolls for the transfer of ink or embossing is included in the scope of the present invention. In accordance with the invention, in any of the embodiments the ink applying system can be controlled to provide a precise quantity of ink to be printed onto the tissue, so that any desired effect of the printed pattern can be achieved. Naturally, the quality of the tissue and the ink can also be taken into account in this regard.

1. A method of producing a printed ink pattern on a tissue having a least two plies, the method comprising the steps of:
applying ink onto a first embossing roll,
passing the at least two plies through a nip formed between the first embossing roll and a second embossing roll, and
embossing the at least two plies in the nip and simultaneously printing the ink onto a surface of the plies being embossed which surface defines an exterior surface of the tissue.

2. A method according to claim 1, further including the step of:
applying ink also onto the second embossing roll and, simultaneously, printing ink also onto another surface of the embossed plies being embossed, which other surface defines the other exterior surface of the tissue.

3. A method according to claim 1, further including the step of:
applying the ink by means of a chamber doctor blade process onto at least one of the first and second embossing rolls.

4. A method according to claim 1, further including the step of:
applying the ink by means of a dip cylinder process onto at least one of the first and second embossing rolls.

5. A method according to claim 1, wherein the first embossing roll is a positive embossing roll with protuberances and depressions, wherein the ink is applied onto some or all of the protuberances of the first embossing roll.

6. A method according to claim 1, wherein the first embossing roll is a positive embossing roll with protuberances and depressions, wherein the ink is applied onto some or all of the depressions of the first embossing roll.

7. A method according to claim 1, wherein the second embossing roll is a positive embossing roll with protuberances and depressions, wherein the ink is applied onto some or all of the protuberances of the second embossing roll.

8. A method according to claim 1, wherein the second embossing roll is a positive embossing roll with protuberances and depressions, wherein the ink is applied onto some or all of the depressions of the second embossing roll.

9. A method according to claim 1, further including the step of:
structuring the at least two plies by means of the simultaneous embossing and printing step.

10. A method according to claim 1, further including the step of:
mechanically bonding the at least two plies together by means of the simultaneous embossing and printing step.

11. A method according to claim 1, further including the step of:
bonding the at least two plies together by means of an adhesive.

12. An apparatus for producing a printed ink pattern on a tissue having at least two plies, comprising:
a first embossing roll and a second embossing roll, the first and second embossing rolls forming an embossing nip therebetween; and
a first ink applying device, wherein the first ink applying device is arranged to apply ink onto the first embossing roll at such a position that, simultaneously to the embossing of the at least two plies in the nip, the ink is printed in the nip onto a surface of the plies being embossed, which surface defines an exterior surface of the tissue.

13. An apparatus according to claim 12, further including:
a second ink applying device ink for applying ink onto the second embossing roll at such a position that, simultaneously to the embossing of the at least two plies in the nip, ink is printed in the nip onto a further surface of the plies being embossed, which further surface defines the other exterior surface of the tissue.

14. An apparatus according to claim 13, wherein at least one of the first ink applying device and the second ink applying device is a chamber doctor blade application system.

15. An apparatus according to claim 12, wherein at least one of the first ink applying device and the second ink applying device is a dip cylinder application system.

16. An apparatus according to claim 12, wherein the first embossing roll is a positive embossing roll comprising protuberances and depressions on the surface thereof and the ink applying device is arranged to apply ink onto some or all of the protuberances.

17. An apparatus according to claim 12, wherein the first embossing roll is a positive embossing roll with protuberances and depression on the surface thereof and the ink applying device is arranged to apply ink onto some or all of the depressions.

18. An apparatus according to claim 12, wherein the second embossing roll is a positive embossing roll with protuberances and depressions on the surface thereof and the further ink applying device is arranged to apply ink onto some or all of the protuberances of the second embossing roll.

19. An apparatus according to claim 12, wherein the second embossing roll is a positive embossing roll with protuberances and depressions on the surface thereof and the ink applying device is arranged to apply ink onto some or all of the depressions of the second embossing roll.

20. An apparatus according to claim 12, wherein the first embossing roll has the same or a different surface structure to a surface structure of the second embossing roll.

21. An apparatus according to claim 12, wherein the first embossing roll has the same as or a different surface material to a surface material of the second embossing roll.

22. An apparatus according to claim 21, wherein at least one of the first and second embossing rolls has a non-elastic surface.

23. An apparatus according to claim 22, wherein the surface material is steel.

24. An apparatus according to claim 12, wherein at least one of the first and second embossing rolls has an elastic surface.

25. An apparatus according to claim 24, wherein the elastic surface is made of a material selected from the group consisting of plastic, rubber, and leather.

26. An apparatus according to claim 12, wherein the nip is adjusted to effect a structuring of the at least two plies of tissue by means of the first and second embossing rolls.

27. An apparatus according to claim 12, wherein the nip is adjusted to effect mechanical bonding of the at least two plies of tissue by means of the first and second embossing rolls.

28. An apparatus according to claim 12, further including an adhesive applying device arranged to apply adhesive to at least one of the plies of tissue to bond the at least two plies together.

29. A tissue product obtained by means of a method according to claim 1.

30. A tissue product comprising a pattern of embossment and a printed ink pattern on at least one external surface thereof, the printed ink pattern being confined to some or all of the embossed areas of the embossed pattern.
